(19) United States
(12) Patent Application Publication
(10) Pub. No.: US 2026/0222803 A1
(43) Pub. Date: Jul. 30, 2026

(54) METHOD AND APPARATUS FOR ESTABLISHING SECURITY CONTEXT IN A WIRELESS COMMUNICATION SYSTEM

(71) Applicant: SAMSUNG ELECTRONICS CO., LTD., Suwon-si, Gyeonggi-do (KR)

(72) Inventors: Rohini RAJENDRAN, Bangalore (IN); Rajavelsamy RAJADURAI, Bangalore (IN); Nivedya Parambath SASI, Bangalore (IN)

(21) Appl. No.: 19/145,867

(22) PCT Filed: Jan. 5, 2024
(86) PCT No.: PCT/KR2024/000282

§ 371 Date: Jul. 3, 2025

(30) Foreign Application Priority Data
Jan. 5, 2023 (IN) 202341001243
Dec. 20, 2023 (IN) 202341001243

(51) Int. Cl. H04W 12/041; H04W 12/0431; H04W 74/0833

(52) U.S. Cl. CPC H04W 12/041; H04W 12/0431; H04W 74/0833

(57) ABSTRACT

The disclosure relates to a 5G or 6G communication system for supporting a higher data transmission rate. The disclosure relates to methods, master node (204) and User Equipment (UE) (202) for establishing security context between the UE (202) and a secondary node of a Secondary Cell Group (SCG) (210). The method comprising configuring a plurality of counter values in a UE (202), for each of a plurality of secondary nodes (206) of a SCG (210). The plurality of counter values is used for generating a security key, upon detecting a Primary Secondary Cell (PSCell) change of the UE (202) to a candidate PSCell of a secondary node from the plurality of secondary nodes (206). The candidate PSCell is previously camped on by the UE (202). The security key is used to establish security context between the UE (202) and the candidate PSCell.

### TECHNICAL FIELD

The disclosure generally relates to telecommunication networks. More particularly, the disclosure relates to establishing security context between a User Equipment (UE) and a secondary node of a Secondary Cell Group (SCG) in a wireless communication system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

New Radio Dual Connectivity (NR-DC) is a dual connectivity configuration using Fifth Generation (5G) standalone core. NR-DC enables simultaneous connections between a User Equipment (UE) and multiple base stations (BS) or gNodeBs (gNBs). NR-DC configuration includes primary/master nodes and nodes as 5G gNBs. A master node is associated with a Secondary Cell Group (SCG) including the secondary nodes. Each of the secondary nodes serve multiple cells or Primary and Secondary Cells (PSCells), as shown in FIG. 1A. PSCell is a cell for which initial access is initiated under the SCG.

A Conditional PSCell Change (CPC) is defined as a PSCell change that is executed by the UE when execution condition(s) is met. The UE starts evaluating the execution condition(s) upon receiving CPC configuration from the master node and stops evaluating the execution condition(s) once the PSCell change is triggered. The CPC configuration contains configuration of CPC candidate PSCell(s) and execution condition(s). Before any CPC execution condition is satisfied, upon reception of PSCell change command, the UE executes the PSCell change procedure. Upon the successful completion of PSCell change procedure or PCell change procedure, the UE releases all stored CPC configurations.

FIG. 1B depicts a scenario in which the UE starts off with single connectivity with the master node or MN. In legacy procedure, once the UE completes the CPA towards a secondary node SN1, the CPA configuration configured initially are released. The network needs to configure the UE again with the CPA configuration in order for the UE to connect to a secondary node SN2. In release 18 of Third Generation Partnership Project (3GPP), same as legacy, cells associated with the secondary nodes SN1 and SN2 are pre-configured to the UE in the CPA configuration as shown in step 3 of FIG. 1B. However, in Release 18, the UE may retain CPC pre-configuration (not released as in legacy) for each candidate SCG after the CPA is executed. The UE continues to monitor whether any of the CPC condition is met for subsequent CPC among the pre-configured candidate SCGs. When the UE moves under a cell coverage, the cell associated with the secondary node SN1 can be added as PSCell while keeping the CPA/CPC configuration (i.e., configuration of the cell associated with the secondary node SN2). Similarly, again the CPA/CPC configuration configured is not released when the UE activates the configuration of the cell associated with the secondary node SN2 while keeping the configuration of the cell associated with the secondary node SN1.

The UE keeps conditional reconfigurations to the other candidate/target PSCells and continues switching between the candidate PSCells multiple times, including a previously selected PSCell. For instance, in a scenario, the UE changes to PSCell #1a controlled by the secondary node SN1, then to PSCell #2a controlled by the secondary node SN2, then to PSCell #1a controlled by the secondary node SN1. In another scenario, the UE changes to PSCell #1a controlled by SN #1, then to PSCell #2a controlled by SN #2, then to PSCell #1b controlled by SN #1.

A security context is established in Fifth Generation (5G) networks where a security key is generated and stored in both the UE and the network. The security key is generated based on a value of a Secondary Node (SN) counter in the conditional reconfigurations. Based on the existing state of art, once the CPC is done UE releases the conditional configurations. Further the UE derives the security key based on a value of the SN counter in the executed conditional reconfiguration. As the conditional configurations are retained and not released, the UE uses the same value of the SN counter in the conditional configurations for generating the security key. The UE generates and uses the same security key every time the UE is connected to the PSCell #1a, i.e. before and after moving to the secondary node SN2. However, using same security key when Packet Data Convergence Protocol (PDCP) anchor point is changed, and/or when UE switches back to same PSCell, in other words leads to key-stream reuse when the UE switches back and forth to the same PSCell (security key repetition) between same endpoints, which is against existing security procedure defined for the PSCell change, as repeating the security key compromises security between the UE and the network.

The information disclosed in this background of the disclosure section is only for enhancement of understanding of the general background of the disclosure and should not be taken as an acknowledgement or any form of suggestion that this information forms the prior art already known to a person skilled in the art.

### DISCLOSURE OF INVENTION

### Solution to Problem

In various embodiments, the disclosure discloses a method of establishing security context between a User Equipment (UE) and a secondary node of a Secondary Cell Group (SCG). The method comprises configuring a plurality of counter values in a UE, for each of a plurality of secondary nodes of a SCG. A counter value among plurality of counter values is used for generating a security key, upon detecting a Primary and Secondary Cell (PSCell) change of the UE to a candidate PSCell of a secondary node from the plurality of secondary nodes. The candidate PSCell is previously camped on by the UE. The security key is used to establish security context between the UE and the candidate PSCell.

In various embodiments, the disclosure discloses a method of establishing security context between a User Equipment (UE) and a secondary node of a Secondary Cell Group (SCG). The method comprises obtaining a plurality of counter values associated with a secondary node. The plurality of counter values is configured in the UE. Further, the method comprises detecting a Primary and Secondary Cell (PSCell) change to a candidate PSCell previously camped on by the UE, associated with a secondary node of a SCG. Furthermore, the method comprises generating a security key for establishing security context between the UE and the candidate PSCell, based on a counter value among the plurality of counter values.

In various embodiments, the disclosure discloses a master node for establishing security context between a User Equipment (UE) and a secondary node of a Secondary Cell Group (SCG). The master node comprises a processor and a memory. The processor is configured to configure a plurality of counter values in a UE, for each of a plurality of secondary nodes of a SCG. A counter value among the plurality of counter values is used for generating a security key, upon detecting a Primary Secondary Cell (PSCell) change of the UE to a candidate PSCell of a secondary node from the plurality of secondary nodes. The candidate PSCell is previously camped on by the UE. The security key is used to establish security context between the UE and the candidate PSCell.

In various embodiments, the disclosure discloses a User Equipment (UE) for establishing security context between a User Equipment (UE) and a secondary node of a Secondary Cell Group (SCG). The UE comprises a processor and a memory. The processor is configured to detect a Primary Secondary Cell (PSCell) change to a candidate PSCell previously camped on by the UE, associated with a secondary node of a SCG. Further, the processor is configured to obtain a plurality of counter values associated with the secondary node, based on detecting the PSCell change. The plurality of counter values is configured in the UE. Furthermore, the processor is configured to generate a security key for establishing security context between the UE and the candidate PSCell, based on a counter value among the plurality of counter values.

The foregoing summary is illustrative only and is not intended to be in any way limiting. In addition to the illustrative aspects, embodiments, and features described above, further aspects, embodiments, and features will become apparent by reference to the drawings and the following detailed description.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The novel features and characteristics of the disclosure are set forth in the appended claims. The disclosure itself, however, as well as a preferred mode of use, further ob-jectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1A illustrates a conventional New Radio Dual Connectivity (NR-DC) architecture;

FIG. 1B illustrates a conventional Master Node (MN)-initiated procedure for Secondary Cell Group (SCG) selective activation;

FIG. 2 illustrates an exemplary environment for establishing security context between a User Equipment (UE) and a secondary node of a SCG, in accordance with some embodiments of the disclosure;

FIG. 3 illustrates a detailed diagram of a master node, in accordance with some embodiments of the disclosure;

FIG. 4 shows an exemplary flow diagram for establishing security context between the UE and the secondary node of the SCG, in accordance with some embodiments of the disclosure;

FIG. 5 illustrates a detailed diagram of the UE, in accordance with some embodiments of the disclosure;

FIG. 6 shows an exemplary flow chart illustrating method steps for establishing security context between the UE and the secondary node of the SCG, in accordance with some embodiments of the disclosure; and

FIG. 7 shows a block diagram of a general-purpose computing system for establishing security context between the UE and the secondary node of the SCG, in accordance with embodiments of the disclosure.

FIG. 8 illustrates a UE according to embodiments as disclosed herein.

FIG. 9 illustrates a base station according to embodiments as disclosed herein.

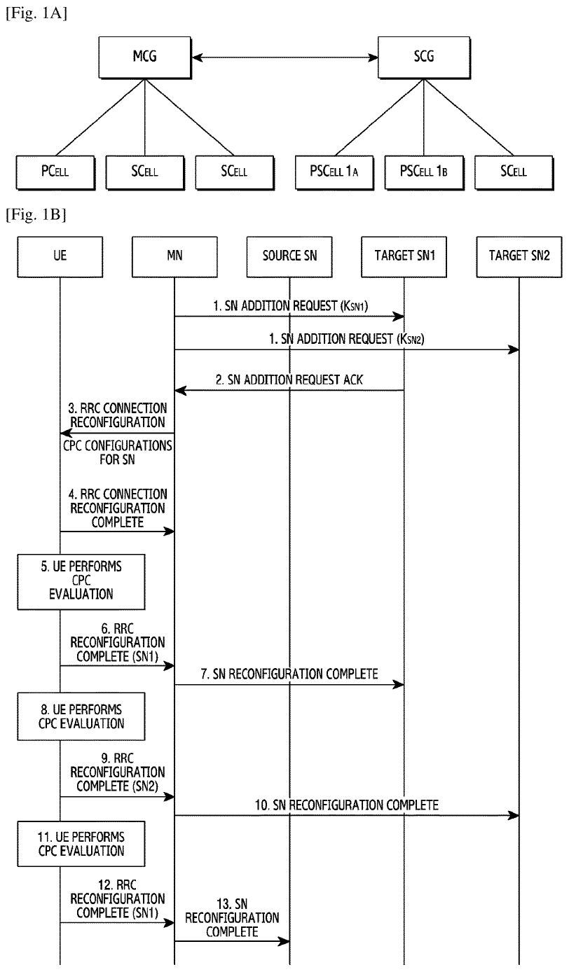

It should be appreciated by those skilled in the art that any block diagram herein represents conceptual views of illustrative systems embodying the principles of the subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### MODE FOR THE INVENTION

In the document, the word “exemplary” is used herein to mean “serving as an example, instance, or illustration.” Any embodiment or implementation of the subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

A Conditional PSCell Change (CPC) is defined as a PSCell change that is executed by the UE when execution condition(s) is met. In release 18 of Third Generation Partnership Project (3GPP), the UE keeps conditional reconfigurations to other candidate/target PSCells and continues switching between the candidate PSCells multiple times, including a previously selected PSCell. A security context is established in Fifth Generation (5G) networks where a security key is generated and stored in both the UE and the network. As the conditional configurations are retained and not released, the UE uses same value of SN counter in the conditional configurations for generating the security key (key-stream re-use). This is against existing security procedure defined for the PSCell change, as repeating the security key compromises security between the UE and the network.

The disclosure discloses methods, a master node, and a User Equipment (UE) for establishing security context between the UE and a secondary node of a Secondary Cell Group (SCG). In the disclosure, the master node configures multiple counter values (in sequence or monotonically increment manner) for each secondary node of the SCG, for multiple Primary Secondary Cell (PSCell) change. The UE detects a PSCell change to a candidate PSCell which is earlier selected or previously camped on by the UE. In such case, the UE obtains the counter values configured for a secondary node associated with the candidate PSCell. The UE generates a security key for establishing security context between the UE (202) and the candidate PSCell, based on a counter value with unused state. This ensures that the UE does not use the same counter value for generating the security key while establishing security context with the candidate PSCell. Further, the UE provides he counter value used to generate the security key to the Secondary Node (SN) via the Master Node (MN), so that the SN ensures it uses the same key avoiding key mismatch. Hence, the security key generated when the UE connects to a previously camped candidate PSCell is not repeated at both UE and network side. This ensures security established between the UE and the network.

The disclosure relates to wireless communications and communication networks. Particularly, but not exclusively, the disclosure relates to a method and system for providing security for selective Secondary Cell Group (SCG) activation in a communication network.

The scenario of NR-DC with selective activation of the cell groups specifies mechanism and procedures of NR-DC with selective activation of the cell groups (at least for SCG) via L3 enhancements to allow subsequent cell group change after changing Cell Group without reconfiguration and re-initiation of Conditional PSCell Change/Conditional PSCell Addition.

In New Radio Dual Connectivity (NR-DC), a PSCell change does not always require a security key change. If a security key change is required, this is performed through a synchronous Secondary Cell Group (SCG) reconfiguration procedure towards the User Equipment (UE). The procedure involves random access on PSCell and a security key change, during which the Medium Access Control (MAC) entity configured for SCG is reset and Radio Link Control (RLC) configured for SCG is re-established regardless of the bearer type(s) established on SCG. For Secondary Node (SN) terminated bearers, Packet Data Convergence Protocol (PDCP) is re-established. In all NR-DC options, to perform this procedure within the same SN, the SN modification procedure is used, setting the PDCP change indication to indicate that a S-K_{gNB} (for EN-DC, NGEN-DC and NR-DC) or S-K_{gNB} (for NE-DC) update is required when the procedure is initiated by the SN or including the SgNB Security Key/SN Security Key when the procedure is initiated by the Master Node (MN).

If a security key change is not required (only possible in EN-DC, NGEN-DC and NR-DC), this is performed through a synchronous SCG reconfiguration procedure without security key change towards the UE involving random access on PSCell.

A Conditional PSCell Change (CPC) is defined as a PSCell change that is executed by the UE when execution condition(s) is met. The UE starts evaluating the execution condition(s) upon receiving the CPC configuration and stops evaluating the execution condition(s) once PSCell change or PCell change is triggered. Intra-SN CPC without MN involvement, inter-SN CPC initiated either by MN or SN are supported.

The following principles apply to CPC: The CPC configuration contains the configuration of CPC candidate PSCell(s) and execution condition(s) and may contain the Master Cell Group (MCG) configuration for inter-SN CPC, to be applied when CPC execution is triggered. An execution condition may consist of one or two trigger condition(s) (see CondEvent, as defined in TS 38.331 or TS 36.331). Only single RS type and at most two different trigger quantities (e.g., RSRP and RSRQ, RSRP and SINR, etc.) can be used for the evaluation of CPC execution condition of a single candidate PSCell.

Before any CPC execution condition is satisfied, upon reception of PSCell change command or PCell change command, the UE executes the PSCell change procedure as described in in TS 38.300 or in TS 36.300, regardless of any previously received CPC configuration. Upon the successful completion of PSCell change procedure or PCell change procedure, the UE releases all stored CPC configurations.

While executing CPC, the UE is not required to continue evaluating the execution condition of other candidate PSCell(s). Once the CPC procedure is executed successfully, the UE releases all stored conditional reconfigurations (i.e., for CPC and for CHO, as specified in TS 38.300 or TS 36.300).

Upon the release of SCG, the UE releases the stored CPC configurations. MN can inform SN of the maximum number of conditional reconfigurations the SN is allowed to configure for SN initiated CPC including both intra-SN and inter-SN CPC. The CPC configuration in HO command, in PSCell addition/change command or within any conditional reconfiguration (i.e. CPA, CPC or CHO configuration) is not supported.

Consider a scenario where the UE starts off with single connectivity with MN (Cell A). In legacy procedure, once the UE completed CPA towards SN #1 (Cell B), the CPA configuration (including all the candidate cells) configured initially are released. Network will need to configure the UE again with CPA/CPC configuration in order for the UE to CPA/CPC to SN #2 (Cell C). In Rel18, same as legacy, Cell B and Cell C can be pre-configured to the UE in the CPA configuration. Release 18 UE may keep the SCG CPC pre-configuration (not released as in legacy) for each candidate SCG after CPA is executed. The UE continues to monitor if any of the CPC condition is met for subsequent CPC among the pre-configured candidate SCGs. When UE moves under the Cell B coverage, the Cell B can be added as PSCell while keeping the CPA/CPC configuration (i.e., configuration of SN #2 of Cell C) after the PSCell addition of Cell B). Similarly, again the CPA/CPC configuration configured is not released when the UE activates the configuration of SN #2 of Cell C while keeping the configuration of SN1 of Cell B.

The above scenario discusses selective SCG activation in which the UE remains connected to the same PCell and is configured with several conditional reconfigurations, each with a different candidate target PSCell, and, based on conditions on measurement results on candidate target PSCells, the UE selects and executes one of these conditional reconfigurations, thus changing PSCell.

After executing a conditional reconfiguration, the UE may keep conditional reconfigurations to the other candidate target PSCells and continue switching between the candidate target PSCells multiple times, including an earlier selected PSCell. All of this happens without any new reconfiguration by the network (i.e., using the stored conditional reconfigurations). The candidate target PSCells may be controlled by different SNs, so the execution of a conditional reconfiguration will sometimes change the serving SN. The serving SNs may have different PDCP anchor points.

The following scenarios are to be supported:
The UE changes to PSCell #1a controlled by SN #1, then to PSCell #2a controlled by SN #2, then to PSCell #1a controlled by SN #1;
The UE changes to PSCell #1a controlled by SN #1, then to PSCell #2a controlled by SN #2, then to PSCell #1b controlled by SN #1.

Based on the existing state of art, once the CPC is done UE releases the old SCG configuration. Further the UE derives the S-KgNB from the SN-counter in the executed conditional reconfiguration, if included. The UE will use the same S-KgNB every time it is connected to PSCell #1a, i.e. before and after moving to SN #2. If the same value of SN-counter is included in the conditional reconfiguration for PSCell #1a and in the conditional reconfiguration for PSCell #1b, the UE will use the same S-KgNB before and after moving to SN #2.

Using same S-KgNB when the PDCP anchor point is changed, in other words security key repetition (key-stream re-use) between the same end-points, is against the existing security procedure defined for PSCell change, as repeating a compromised key will compromise the security of the system repeatedly. The term “SN”, “Secondary Node” and “SCG (Secondary Cell Group)” are used interchangeably throughout this document. The term “MN” and “MCG” are used interchangeably throughout this document. The term “SCG counter”, “sk-Counter” “counter value”, “random number”, “index” and “SN Counter” are used interchangeably throughout this document. The term “sequence” and “monotonically increment” are used interchangeably throughout this document.

In various embodiments, the disclosure relates to method and system for providing security for selective Secondary Cell Group (SCG) activation. According to the disclosure, a Counter_{selectiveSCG} is maintained at the UE and is used as an input to Key Distribution Function (KDF) for derivation of S-K_{gNB}. In another embodiment, a Counter_{selectiveSCG} is maintained at the UE and is used as an input to KDF for derivation of S-K_{gNB} along with the SCG counter. The UE sets the Counter_{selectiveSCG} to ‘0’ when a new S-K_{gNB} is derived using configured SCG counter and root key K_{NG-RAN}, in the associated 5G AS security context is established. The MN and UE sets the Counter_{selectiveSCG} to ‘1’ after the first calculated S-K_{gNB}, and monotonically increments it for each additional calculated S-K_{gNB} when UE switches back to same PSCell. In another embodiment, Physical Cell ID (PCI) is used as an input to KDF in addition to or instead of Counter_{selectiveSCG} for derivation of S-K_{gNB}. In another embodiment, C-RNTI is used as an input to KDF for derivation of S-K_{gNB} in addition to or instead of Counter selectiveSCG.

In another embodiment, new S-K_{gNB} is generated by the UE and the SN using at least any one of the following as input parameter to Key Derivation Function (KDF): Counter_{selectiveSCG}, C-RNTI, PCI, existing S-K_{gNB}, SCG Counter.

In another embodiment, new S-K_{gNB} is generated by the UE and the MN using at least any one of the following as input parameter to the KDF: Counter_{selectiveSCG}, C-RNTI, PCI, existing K_{gNB}, SCG Counter The MN provide the newly derived key S-K_{gNB to} the SN (when requested by SN or unsolicitedly).

Alternative 1: Inclusion of a new counter for selective SCG activation

A derivation for S-K_{gNB} with inclusion of Random number/Counter_{selectiveSCG} is disclosed. In various embodiments, the UE and/or MN and/or SN has to maintain the state of used/un-used Counter_{selectiveSCG}.

In various embodiments, a Counter_{selectiveSCG} is maintained at the UE and is used as an input to Key Derivation Function (KDF) for derivation of S-K_{gNB}. The UE provides the Counter_{selectiveSCG} along with other possible parameters (like, PCI, C-RNTI) to the SN in a RRC message. On receiving the Counter_{selectiveSCG} from the UE, the SN request the MN in a message over Xn AP interface to generate and provide the fresh key S-K_{gNB}. The SN includes the Counter_{selectiveSCG} and other possible parameters (like, PCI, C-RNTI) in the request message. Based on the request from the SN, the MN generates the key S-K_{gNB} and includes the generated S-K_{gNB} in response to the request over Xn AP interface.

A derivation for S-K_{gNB} with inclusion of SCG counter and Random number/Counter_{selectiveSCG} is disclosed. In another embodiment, a Counter_{selectiveSCG} is maintained at the UE and is used as an input to KDF for derivation of S-K_{gNB} along with the SCG counter. The UE sets the Counter_{selectiveSCG} to ‘0’ when a new S-K_{gNB} is derived using configured SCG counter and root key K_{NG-RAN}, in the associated 5G AS security context is established. The MN and UE sets the Counter_{selectiveSCG} to ‘1’ after the first calculated S-K_{gNB}, and monotonically increment it for each additional calculated S-K_{gNB} when UE switches back to same PSCell.

In various embodiments, the UE generates and assigns a random number which is used as an input to KDF for derivation of S-K_{gNB}. This random number is then provided to the SCG during SN transfer by the UE. This input string is used when the MN and UE derive S-K_{gNB} from K_{gNB} during selective SCG activation. The following input parameters is to be used:

$$FC = 0 xxx$$

$$P 0 = Value of the Random number / {Counter}_{selectiveSCG}$$

$$L 0 = length of the {Counter}_{selectiveSCG}$$

The input key KEY shall be K_{eNB} when the MN is an ng-eNB and the KEY shall be K gNB When the MN is a gNB.

This input string is used when the MN and UE derive S-K_{gNB} from K_{gNB} during selective SCG activation. The following input parameters is be used:

$$FC = 0 xxx$$

$$P 0 = Value of the {Counter}_{selectiveSCG}$$

$$L 0 = length of the {Counter}_{selectiveSCG}$$

$$P 1 = Value of the SCG Counter as a non - negative integer$$

$$L 1 = length of the SCG Counter value$$

The input key KEY shall be K_{eNB} when the MN is an ng-eNB and KEY shall be K_{gNB} when the MN is a gNB. The MN or SN initiates the conditional SN change by requesting the candidate SN(s) to allocate resources for the UE by means of the SgNB Addition procedure, indicating that the request is for Conditional PSCell Addition and Change (CPAC). The MN also provides the candidate cells recommended by MN via the latest measurement results for the candidate SN(s) to choose and configure the SCG cell(s), and provides the upper limit for the number of PSCells that can be prepared by the candidate SN.

The candidate S-gNB acknowledges the request received by the MN. In this step the SN provides the corresponding SCG radio resource configuration to the MN in an NR RRCReconfiguration message contained in the SgNB Addition Request Acknowledge message.

As it is selective conditional reconfiguration, the MN initiates normal RRC reconfiguration to update the conditional configuration. The MN sends a RRCReconfiguration message or any new RRC message, for example, RRC_selectiveSCGactivation to the UE with a PDCP anchor change indication. In various embodiments, MN initiates an RRC reconfiguration with a “PDCP anchor point change due to selective SCG” indicator. With this indicator UE is aware of not releasing the conditional configuration.

In step 4, in cases where, the PDCP Change Indication is received over RRC message for example RRC_selectiveSCGactivation, it indicates that an S-K_{gNB} update is required. The UE acknowledges the request for S-K_{gNB} change indicated based on PDCP change indicator. Based on the received indication the UE derives/generates Counter_{selectiveSCG} or random number as defined in one of the embodiments herein and may use it as an input parameter to derive S-K_{gNB}. The UE sends a RRCReconfiguration complete message. The message includes the generated Counter_{selectiveSCG}/random number.

In step 5, the MN informs the SN of the selected candidate PSCell that the UE has completed the reconfiguration procedure successfully via SgNB Reconfiguration Complete message, including the RRCReconfigurationComplete message. Based on the received Counter_{selectiveSCG} or random number the SN derive S-K_{gNB}. In various embodiments, the UE provides the Counter_{selectiveSCG} or random number, so that the SN ensures it uses the same key avoiding key mismatch.

In various embodiments, the SN is configured with more than one K_{SN} for selective CPAC (Conditional PScell Addition or Change) and when receiving the Counter_{se lectiveSCG} or random number the SN selects the appropriate K_{SN} based on the received counter value for subsequent switching between PSCell. In various embodiments, the random number is in a monotonically increasing indexed numbers.

The UE and MN/SN further proceeds with RACH procedure as defined in TS 38.331.

In various embodiments, the PSCell always requires a security key change. If a security key change is required, it is performed through a synchronous SCG reconfiguration procedure as defined in one of the embodiments herein, towards the UE involving random access on PSCell and a security key change.

For SN terminated bearers, PDCP is re-established with the target/other candidate SNs to perform this procedure in inter-SN scenarios, the SN Addition/Modi-fication/Change procedure setting the PDCP Change Indication to indicate that a S-K_{gNB} update is required when the procedure is initiated by the SN or including the SgNB Security Key/SN Security Key when the procedure is initiated by the MN.

In various embodiments, UE sends the Counterselective_{SCG}/random number during RRC setup procedure in at least one of: RRC connection setup request, RRC connection setup complete message to the SN via MN.

In various embodiments, based on the PDCP change indication, the UE derives the key using the Counter_{selectiveSCG}/random number, only if there is no valid unused SCG Counter available.

Alternative 2: Inclusion of PCI as an input parameter for key derivation in selective SCG activation

In another embodiment, the Secondary Node Change procedure is initiated either by MN or SN and used to transfer a UE context from a source SN to a target SN and to change the SCG configuration in UE from one SN to another. In case of CPC, the Conditional Secondary Node Change procedure initiated either by the MN or SN is also used for CPC configuration and CPC execution.

A MN initiated Secondary Node change/modification is disclosed. The MN initiates the conditional SN change by requesting the candidate SN(s) to allocate resources for the UE by means of the SgNB Addition procedure, indicating that the request is for CPAC. The MN also provides the candidate cells recommended by MN via the latest measurement results for the candidate SN(s) to choose and configure the SCG cell(s), and provides the upper limit for the number of PSCells that can be prepared by the candidate SN. The candidate S-gNB acknowledges the request received by the MN.

After executing a selective conditional reconfiguration, the UE may keep conditional reconfigurations to the other candidate target PSCells, i.e., the CPA configuration pre-configured is not released.

In step 4, as it is selective conditional reconfiguration, the MN does not initiate RRC reconfiguration procedure. The MN sends a RRC message for example RRC_selectiveSCGactivation to the UE with a PDCP anchor change indication. In various embodiments, MN initiates an RRC reconfiguration with a “PDCP anchor point change due to selective SCG” indicator. With this indicator UE is aware of not releasing the conditional configuration.

In step 5, in cases where, the PDCP Change Indication is received over RRC message for example RRC_selectiveSCGactivation, it indicates that an S-K_{gNB} update is required. The UE acknowledges the request for S-K_{gNB} change indicated using PDCP change indicator.

In step 6, based on the received indication the UE derives/generates an updated S-K gNB key further as follows:

Derivation of S-K_{gNB #1} (for candidate S-gNB #1):

This input string is used when the MN and UE derive S-K_{gNB #1} from S-K_{gNB} during selective SCG activation. The following input parameters is to be used:

$$FC = 0 xxx$$

$$P 0 = Value of the SCG Counter as a non - negative integer$$

$$L 0 = length of the SCG Counter value$$

$$P 1 = Value of the Physical Cell Identifier ( PCI )$$

$$L 1 = length of the Physical Cell Identifier ( PCI )$$

Derivation of S-K_{gNB #2} (for candidate S-gNB #2):

This input string is used when the MN and UE derive S-K_{gNB #2} from S-K_{gNB #1} during selective SCG activation where the differentiation parameter is PCI and the root key is previously generated key (S-K_{gNB #1}). The following input parameters is to be used:

$$FC = 0 xxx$$

$$P 0 = Value of the SCG Counter as a non - negative integer$$

$$L 0 = length of the SCG Counter value$$

$$P 1 = Value of the Physical Cell Identifier ( PCI )$$

$$L 1 = length of the Physical Cell Identifier ( PCI )$$

In another embodiment, derivation of S-K_{gNB #2} (for candidate S-gNB #2). This input string is used when the MN and UE derive S-K_{gNB #2} from S-K_{gNB} during selective SCG activation, where the differentiation parameter is PCI and the root key is the initial S-K_{gNB} generated from K_{gNB}. The following input parameters in be used:

$$FC = 0 xxx$$

$$P 0 = Value of the SCG Counter as a non - negative integer$$

$$L 0 = length of the SCG Counter value$$

$$P 1 = Value of the Physical Cell Identifier ( PCI )$$

$$L 1 = length of the Physical Cell Identifier ( PCI )$$

The UE and MN/SN further proceeds with RACH procedure as defined in TS 38.331.

A SN initiated Secondary Node change/modification is disclosed. The SN initiates the conditional SN change by requesting the candidate MN. The MN sends an SN change request to the candidate SN to allocate resources for the UE by means of the SgNB Addition procedure, indicating that the request is for CPAC. The MN also provides the candidate cells recommended by MN via the latest measurement results for the candidate SN(s) to choose and configure the SCG cell(s), and provides the upper limit for the number of PSCells that can be prepared by the candidate SN. The candidate S-gNB acknowledges the request received by the MN.

After executing a selective conditional reconfiguration, the UE may keep conditional reconfigurations to the other candidate target PSCells, i.e., the CPA configuration pre-configured is not released.

As it is selective conditional reconfiguration, the MN does not initiate RRC reconfiguration procedure. The MN sends a RRC message for example RRC_selectiveSCGactivation to the UE with a PDCP anchor change indication. In cases where, the PDCP Change Indication is received over RRC message for example RRC_selectiveSCGactivation, it indicates that a S-K_{gNB} update is required. The UE acknowledges the request for S-K_{gNB} change indicated using PDCP change indicator. Based on the received indication the UE derives/generates an updated S-K_{gNB} key further as follows:

Derivation of S-K_{gNB #1} (for candidate S-gNB #1):

This input string is used when the MN and UE derive S-K_{gNB #1} from S-K_{gNB} during selective SCG activation. The following input parameters in be used:

$$FC = 0 xxx$$

$$P 0 = Value of the SCG Counter as a non - negative integer$$

$$L 0 = length of the SCG Counter value$$

$$P 1 = Value of the Physical Cell Identifier ( PCI )$$

$$L 1 = length of the Physical Cell Identifier ( PCI )$$

Derivation of S-K_{gNB #2} (for candidate S-gNB #2). This input string is used when the MN and UE derive S-K_{gNB #2} from S-K_{gNB #1} during selective SCG activation where the differentiation parameter is PCI and the root key is previously generated key (S-K_{gNB #1}). The following input parameters shall be used:

$$FC = 0 xxx$$

$$P 0 = Value of the SCG Counter as a non - negative integer$$

$$L 0 = length of the SCG Counter value$$

$$P 1 = Value of the Physical Cell Identifier ( PCI )$$

$$L 1 = length of the Physical Cell Identifier ( PCI )$$

In another embodiment, derivation of S-K_{gNB #2} (for candidate S-gNB #2). This input string is used when the MN and UE derive S-K_{gNB #2} from S-K_{gNB} during selective SCG activation, where the differentiation parameter is PCI and the root key is the initial S-K_{gNB} generated from K_{gNB}. The following input parameters shall be used:

$$FC = 0 xxx$$

$$P 0 = Value of the SCG Counter as a non - negative integer$$

$$L 0 = length of the SCG Counter value$$

$$P 1 = Value of the Physical Cell Identifier ( PCI )$$

$$L 1 = length of the Physical Cell Identifier ( PCI )$$

The UE and MN/SN further proceeds with RACH procedure as defined in TS 38.331.

Alternative 3: Setting up a Counter_{selectiveSCG}

The MN and UE maintains a 16-bit counter, Counter_{selectiveSCG}, in its AS security context. The Counter_{selectiveSCG} is used when computing the S-K_{gNB #1} during selective SCG activation after the execution of conditional reconfiguration.

The MN and UE maintains the value of the Counter_{selectiveSCG} for a duration of the current 5G AS security context between UE and MN. The Counter_{selectiveSCG} fresh input to S-K_{gNB #1} derivation.

The MN and UE sets the Counter_{selectiveSCG} to ‘0’ when a new S-K_{gNB} is derived using configured SCG counter and root key K_{NG-RAN}, in the associated 5G AS security context is established. The MN and UE sets the Counter_{selectiveSCG} to ‘1’ after the first calculated S-K_{gNB #1}, and monotonically increment it for each additional calculated S-K_{gNB #x}. The Counter_{selectiveSCG} value ‘O’ is used to calculate the first S-K_{gNB} #1.

Alternative 4: Configuring N SCG counter value

In various embodiments, the UE is configured with ‘N’ conditional configuration for N PSCell change in a sequence or monotonically incrementing manner. Limitation of this alternative is that CPC is possible only once. Once all the N SCG counters are used the UE cannot fall back to same PSCell and reuse the Configuration (i.e., SCG counter) or awaits for new set of counter values to be configured from the MN. Then it may be required to update or reconfigure the Conditional configuration information. The subsequent cell change means that network resources need to be reserved for a longer time, which may increase the network overhead and reduce the system capacity. Hence, in various embodiments the network configures a timer value for the SCG configuration release.

In another embodiment, UE releases the SCG configuration only when there is change in MN.

In various embodiments, UE sends the information on number of candidate SCG it can support. Based on that the MN configures the conditional configuration information. In various embodiments, the MN generates multiple SN counter values in a sequence or monotonically incrementing manner, derives the K_{SN} corresponding to the SN counter(s) and configures the derived key and counter value to the respective SN nodes (PScells).

For example,

```
{
  Conditional configuration for PSCell#1a (SCG Counter = 1);
  Conditional configuration for PSCell#1b (SCG Counter = 2);
  Conditional configuration for PSCell#2a (SCG Counter = 3);
  :
  :
  Conditional configuration for PSCell#N (SCG Counter = N).
}
```

In various embodiments, the MN configures the UE with one or more than one counter values for a PSCell in a sequence or monotonically incrementing manner as part of conditional configuration information.

For example,

```
{
  Conditional configuration for PSCell#1a (SCG Counter values = 1, 2, 3, ..., N);
  Conditional configuration for PSCell#1b (SCG Counter values = N+1, N+2, .... M);
  :
  :
}
```

In various embodiments, the counter used for dual connectivity and selective CPAC (Conditional PScell Addition or Change) is same i.e., for example if SN counter 1 is assigned for DC then for Subsequent CPAC procedure SN counter values {SN counter 2, SN counter 3, so on} are assigned.

In another embodiment, counter used for selective CPAC and DC are maintained separately.

Alternative 5: Combined alternative 2 and alternative 3-Inclusion of PCI and Setting up a CounterselectiveSCG, using both as input to S-K_{gNB} derivation

In various embodiments, alternative 1 and alternative 2 are combined to provide new method for key update as follows:

Derivation of S-K_{gNB #1} (for candidate S-gNB #1 for illustrative purpose):

This input string is used when the MN and UE derive S-K_{gNB #1} from S-K_{gNB} during selective SCG activation. The following input parameters shall be used:

$$FC = 0 xxx$$

$$P 0 = Value of the SCG Counter as a non - negative integer$$

$$L 0 = length of the SCG Counter value$$

$$P 1 = Value of the Physical Cell Identifier ( PCI )$$

$$L 1 = length of the Physical Cell Identifier ( PCI )$$

$$P 2 = Value of the {Counter}_{selectiveSCG}$$

$$L 2 = length of the {Counter}_{selectiveSCG}$$

Derivation of S-K_{gNB #2} (for candidate S-gNB #2 for illustrative purpose):

This input string is used when the MN and UE derive S-K_{gNB #2} from S-K_{gNB #1} during selective SCG activation where the differentiation parameter is PCI, Counter_{selectiveSCG} and the root key is previously generated key (S-K_{gNB #1}). The following input parameters is used:

$$FC = 0 xxx$$

$$P 0 = Value of the SCG Counter as a non - negative integer$$

$$L 0 = length of the SCG Counter value$$

$$P 1 = Value of the Physical Cell Identifier ( PCI )$$

$$L 1 = length of the Physical Cell Identifier ( PCI )$$

$$P 2 = Value of the {Counter}_{selectiveSCG}$$

$$L 2 = length of the {Counter}_{selectiveSCG}$$

In another embodiment, derivation of S-K_{gNB #2} (for candidate S-gNB #2 for illustrative purpose):

This input string is used when the MN and UE derive S-Kg from S-K_{gNB} during selective SCG activation, where the differentiation parameter is PCI, CounterselectiveSCG and the root key is the initial S-K_{gNB} generated from K_{gNB}. The following input parameters is be used:

$$FC = 0 xxx$$

$$P 0 = Value of the SCG Counter as a non - negative integer$$

$$L 0 = length of the SCG Counter value$$

$$P 1 = Value of the Physical Cell Identifier ( PCI )$$

$$L 1 = length of the Physical Cell Identifier ( PCI )$$

$$P 2 = Value of the {Counter}_{selectiveSCG}$$

$$L 2 = length of the {Counter}_{selectiveSCG}$$

Alternative 6: Inclusion of Cell-Radio Network Temporary Identifier (C-RNTI) as an input parameter for key derivation in selective SCG activation

In this embodiment, C-RNTI is included as the input parameter for S-K_{gNB #1} from S-K_{gNB}

Derivation of S-K_{gNB #1} (for candidate S-gNB #1 for illustrative purpose):

This input string is used when the MN and UE derive S-K_{gNB #1} from S-K_{gNB} during selective SCG activation. The following input parameters shall be used:

$$FC = 0 xxx$$

$$P 0 = Value of the SCG Counter as a non - negative integer$$

$$L 0 = length of the SCG Counter value$$

$$P 1 = Value of the C - RNTI$$

$$L 1 = length of the C - RNTI$$

C-RNTI is dedicated to a particular UE. The gNB assigns different C-RNTI values to different UEs. When Carrier Aggregation is configured, the same C-RNTI applies to all serving cells.

Two C-RNTIs are independently allocated to the UE: one for MCG, and one for SCG. In that case the UE uses C-RNTI for the SCG as input for the key derivation.

In various embodiments, for selective SCG activation the UE and SN maintains the C-RNTI associated with the old security context. The UE sends the old C-RNTI to the SN in an RRC message and SN uses the C-RNTI to retrieve the old context. SN derives and assigns a new C-RNTI to the UE. This new C-RNTI is then used as an input to derive the new S-K_{gNB}.

In another embodiment, On request from the UE to get SN access in a RRC message request to the SN, the SN request the MN to generate and provide the fresh key S-K_{gNB} in a message over Xn AP interface Based on the request from the SN, the MN generates the key and includes the key S-K_{gNB} in response to the request over Xn AP interface. The MN includes the necessary parameters (for example, SCG Counter) required for the UE to generate the S-K_{gNB} in the response message to the SN. The SN forwards the required parameters received from the MN to the UE. On receiving the parameters required for the generation of the key, the UE generates S-K_{gNB}.

In various embodiments, the UE assigns and maintains a Counter_{selectiveSCG} and provides it to the SN in RRC message to ensure SN uses same key to avoid key mismatch. In another embodiment, SN assigns and maintains a Counter_{selectiveSCG} and provides it to the UE in RRC message. In another embodiment, the UE assigns and maintains a Counter_{selectiveSCG} and provides it to the SN in RRC message. The SN shares the Counter_{selectiveSCG} to the MN and MN derives the S-K_{gNB #1} and provides it to the SN.

In various embodiments, SN indicates to the MN about the SN counter usage (already used SN counter) and then MN provides new SN counter to the UE in the RRC reconfiguration message.

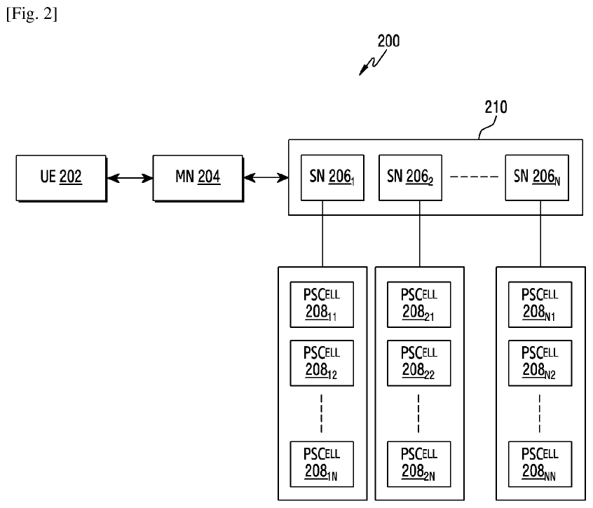

FIG. 2 illustrates an exemplary environment 200 for establishing security context between a User Equipment (UE) and a secondary node of a Secondary Cell Group (SCG), in accordance with the embodiments of the disclosure. The exemplary environment 200 comprises a UE 202, a master node 204 (also referred as a MN 204), and a SCG 210. The disclosure relates to establishing security context between the UE 202 and a secondary node of the SCG 210. The UE 202 may be any device configured to communicate in a wireless network that supports New Radio Dual Connectivity (NR-DC). Examples of the UE 202 include, but not limited to, mobile phones, smartphones, laptops, wearables, and the like.

NR-DC is a dual connectivity configuration using Fifth Generation (5G) standalone core. NR-DC enables simultaneous connections between the UE 202 and multiple base stations (BS) or gNodeBs (gNBs). In NR-DC, the UE 202 is connected to one gNB that acts as the master node 204 and one gNB that acts as a secondary node. The master node 204 is connected to 5G Core (5GC). The master node 204 is associated with the SCG 210 comprising a plurality of secondary nodes 206₁, 206₂, . . . 206_{N}. The plurality of secondary nodes 206₁, 206₂, . . . 206_{N} are also referred as the plurality of secondary nodes 206 in the description. A Secondary Node (also referred as SN) of the plurality of secondary nodes 206 is connected to the master node 204 via ‘Xn’ interface. Each of the plurality of secondary nodes 206 is associated with a plurality of Primary Secondary Cells (PSCells). For instance, a secondary node 206₁ is associated with PSCells 208₁₁, 208₁₂, . . . 208_{IN}. Similarly, a secondary node 206₂ is associated with PSCells 208₂₁, 208₂₂, . . . 208_{2N}. The plurality of PSCells is also referred to as the plurality of PSCells 208 in the description.

A security context is established in Fifth Generation (5G) networks where a security key is generated and stored in both the UE 202 and the secondary node. Security parameters for authentication, integrity protection and ciphering are tied together in a 5G Non-Access Stratum (NAS) security context. Before security is activated, a network and the UE needs to establish the security context. The security context is created as the result of a primary authentication and key agreement procedure UE and the network. The security key is generated based on a value of a SN counter in conditional reconfigurations transmitted to the UE 202 by the MN 204.

In the disclosure, the master node 204 is configured to establish security context between the UE 202 and a secondary node of the SCG 210. Herein, the master node 204 configures multiple counter values for each of the plurality of secondary nodes 206 of the SCG 210. The master node 204 transmits a Radio Resource Control (RRC) reconfiguration message comprising configuration of the plurality of counter values to the UE 202. A counter value among the multiple counter values is used by the UE 202 every time when the UE 202 selects a previously camped candidate PSCell of a secondary node of the SCG 210. The security key is generated by the UE 202 using the counter value. Also, the MN 204 receives the counter value from the UE 202 to generate the security key for establishing the security context between the UE 202 and the candidate PSCell. The counter value is received directly from the UE 202 or via the secondary node associated with the SCG 210.

In the disclosure, the UE 202 is configured to establish security context between the UE 202 and a secondary node of the SCG 210. Herein, the UE 202 UE 202 obtains multiple counter values configured for a secondary node from a plurality of secondary nodes 206. Further, the UE 202 detects a PSCell change to a candidate PSCell previously camped on by the UE 202. In such case, the UE 202 generates a security key for establishing security context between the UE 202 and the candidate PSCell, based on a counter value among the plurality of counter values. The counter value is selected among the plurality of counter values based on a state associated with each of the plurality of counter values, wherein the state is one of, a used state and an unused state. In this way, the UE 202 uses different counter values configured by the MN 204 to generate the security key every time the UE 202 detects a PSCell change to a previously camped PSCell. This eliminates repetition of security key generated for establishing the security context between the UE 202 and the candidate PSCell.

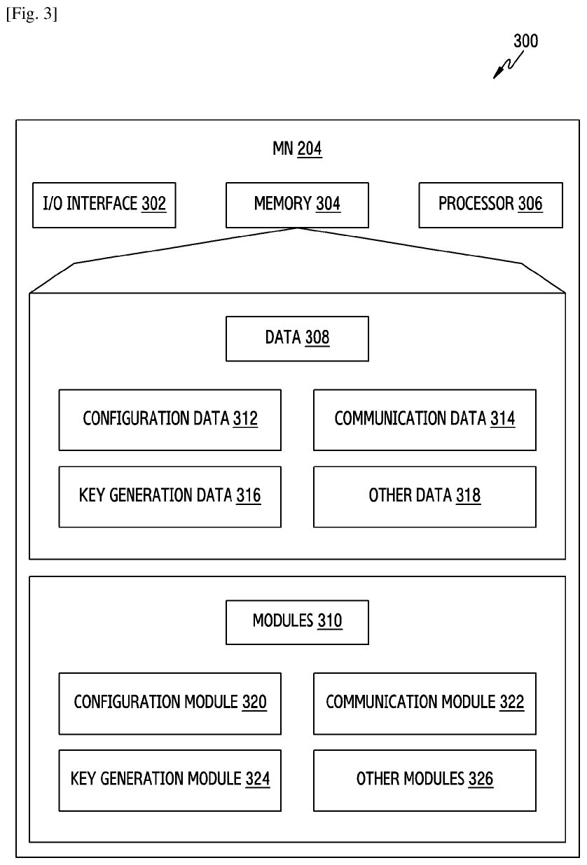

FIG. 3 illustrates a detailed diagram 300 of the master node 204 for establishing the security context between the UE 202 and the secondary node of the SCG 210, in accordance with some embodiments of the disclosure. The master node 204 may include Central Processing Units 306 (also referred as “CPUs” or “a processor 306”), Input/Output (I/O) interface 302, and a memory 304. In some embodiments, the memory 304 may be communicatively coupled to the processor 306. The memory 304 stores instructions executable by the processor 306. The processor 306 may comprise at least one data processor for executing program components for executing user or system-generated requests. The memory 304 may be communicatively coupled to the processor 306. The memory 304 stores instructions, executable by the processor 306, which, on execution, may cause the processor 306 to establish the security context between the UE 202 and the secondary node of the SCG 210. In various embodiments, the memory 304 may include one or more modules 310 and data 308. The one or more modules 310 may be configured to perform the steps of the disclosure using the data 308, to establish the security context between the UE 202 and the secondary node of the SCG 210. In various embodiments, each of the one or more modules 310 may be a hardware unit which may be outside the memory 304 and coupled with the master node 204. As used herein, the term modules 310 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 310 when configured with the described functionality defined in the disclosure will result in a novel hardware. Further, the I/O interface 302 is coupled with the processor 306 through which an input signal or/and an output signal is communicated.

In one implementation, the modules 310 may include, for example, a configuration module 320, a communication module 322, a key generation module 324, and other modules 326. It will be appreciated that such aforementioned modules 310 may be represented as a single module or a combination of different modules. In one implementation, the data 308 may include, for example, configuration data 312, communication data 314, key generation data 316, and other data 318.

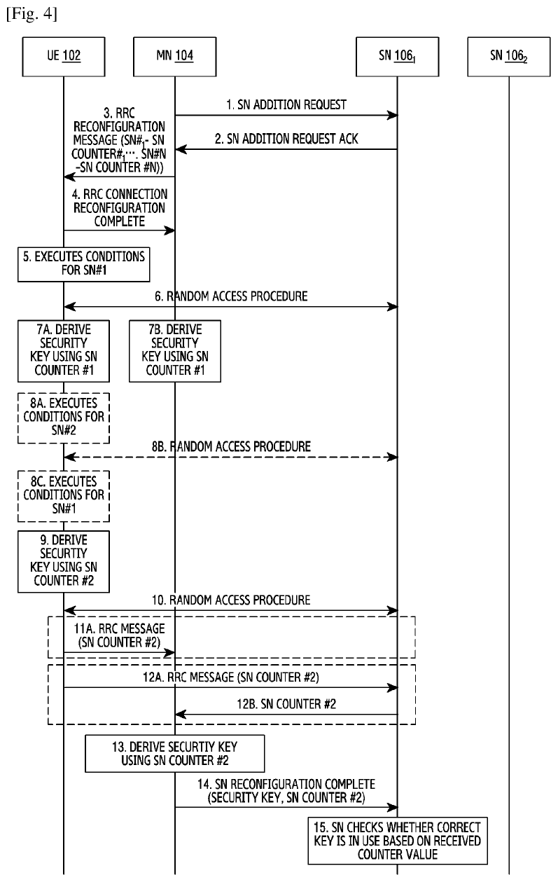

In various embodiments, the configuration module 320 configures a plurality of counter values in the UE 202. Firstly, the configuration module 320 may be configured to generate a plurality of counter values in monotonic increment (sequence manner) associated with the secondary node, to prevent key-stream reuse when the UE 202 switches back and forth to the same PSCell or the SN. The configuration module 320 configures the plurality of counter values, upon sending SN addition request to the plurality of secondary nodes 206 of the SCG 210. The configuration module 320 configures the plurality of counter values for each of the plurality of secondary nodes 206 of the SCG 210. For example, consider the SCG 210 comprises a secondary node 1, a secondary node 2, and a secondary node 3. The configuration module 320 may configure five counter values to each of the secondary node 1, the secondary node 2, and the secondary node 3. In various embodiments, the configuration module 320 transmits a Radio Resource Control (RRC) reconfiguration message to the UE 202 subsequent to receiving acknowledgement from the plurality of secondary nodes 206 corresponding to the SN addition request. The RRC reconfiguration message may comprise the configuration of the plurality of counter values. In an example, the plurality of counter values may be in an incremental order. For example, the plurality of counter values may be 1, 2, 3, 4, and 5. In another example, the plurality of counter values may be 16-bit values. A person skilled in the art will appreciate that the plurality of counter values may be in any other format. Referring to a flow diagram illustrated in FIG. 4, the configuration module 320 may transmit the RRC reconfiguration message at step 3, upon sending the SN addition request and receiving acknowledgement to and from the SN 1061. As shown, the RRC reconfiguration message may include the plurality of counter values. Referring back to FIG. 3, the plurality of counter values may be stored as the configuration data 312 in the memory 304.

In various embodiments, the communication module 322 may be configured to receive a counter value from the plurality of counter values from the UE 202. The UE 202 may select a counter value from the plurality of counter values configured at the UE 202 for generation of the security key. The communication module 322 may receive the said counter value from the UE 202. In an example, consider the UE 202 switches back to PSCell #la associated with a secondary node SN1 from PSCell #1b associated with a secondary node SN2. The UE 202 may use the counter value ‘2’ to generate the security key for establishing security context with the PSCell #la. The communication module 322 may receive the counter value of ‘2’ from the UE 202.

In various embodiments, the communication module 322 may receive the counter value directly from the UE 202. In another embodiment, the communication module 322 may receive the counter value via a secondary node associated with the SCG 210. For example, the communication module 322 may receive the counter value via the secondary node SN1. Referring again to FIG. 4, the communication module 322 may receive the counter value directly from the UE 202 at step 11. According to another embodiment, communication module 322 may receive the counter value via a secondary node associated with the SCG 210 at steps 12A and 12B. Referring back to FIG. 3, the counter value may be stored as the communication data 314 in the memory 304.

In various embodiments, the key generation module 324 may be configured to receive the counter value from the communication module 322. Further, the key generation module 324 may be configured to generate the security key based on the counter value. In various embodiments, the key generation module 324 may implement a Key Distribution Function (KDF) for generation/derivation of the security key (S-K_{gNB}) using the counter value. A person skilled in the art will appreciate that other techniques/methods may be used to generate the security key based on the counter value. Referring again to FIG. 4, the key generation module 324 may generate the security key by providing the counter value ‘2’ to the KDF at step 13. Referring again to FIG. 3, In various embodiments, the key generation module 324 may be configured to maintain a state of the counter value. The state of the counter value may be used state and unused state. The key generation module 324 may maintain the state of the counter as used, once the counter value is used for generating the security key. The generated security key and the counter value used for generation of the security key, and the state of the counter value may be stored as the key generation data 316.

The other data 318 may store data, including temporary data and temporary files, generated by the one or more modules 310 for performing the various functions of the master node 204. The one or more modules 310 may also include the other modules 326 to perform various miscellaneous functionalities of the master node 204. The other data 318 may be stored in the memory 304. It will be appreciated that the one or more modules 310 may be represented as a single module or a combination of different modules.

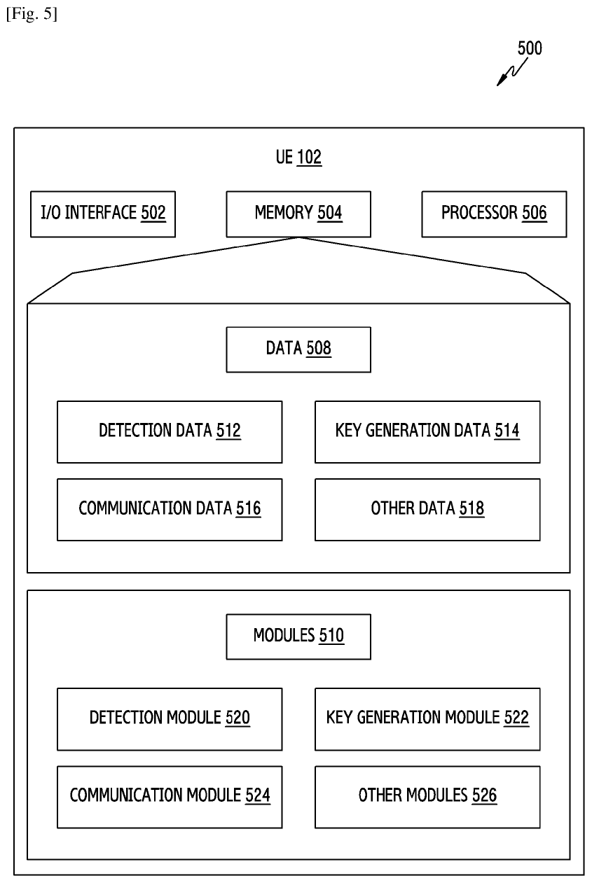

FIG. 5 illustrates a detailed diagram 500 of the UE 202 for establishing the security context between the UE 202 and the secondary node of the SCG 210, in accordance with some embodiments of the disclosure. The UE 202 may include Central Processing Units 506 (also referred as “CPUs” or “a processor 506”), Input/Output (I/O) interface 502, and a memory 504. In some embodiments, the memory 504 may be communicatively coupled to the processor 506. The memory 504 stores instructions executable by the processor 506. The processor 506 may comprise at least one data processor for executing program components for executing user or system-generated requests. The memory 504 may be communicatively coupled to the processor 506. The memory 504 stores instructions, executable by the processor 506, which, on execution, may cause the processor 306 to establish the security context between the UE 202 and the secondary node of the SCG 210. In various embodiments, the memory 504 may include one or more modules 510 and data 508. The one or more modules 510 may be configured to perform the steps of the disclosure using the data 508, to establish the security context between the UE 202 and the secondary node of the SCG 210. In various embodiments, each of the one or more modules 510 may be a hardware unit which may be outside the memory 504 and coupled with the UE 202. As used herein, the term modules 510 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 510 when configured with the described functionality defined in the disclosure will result in a novel hardware. Further, the I/O interface 502 is coupled with the processor 506 through which an input signal or/and an output signal is communicated.

In one implementation, the modules 510 may include, for example, a detection module 520, a key generation module 522, a communication module 524, and other modules 526. It will be appreciated that such aforementioned modules 510 may be represented as a single module or a combination of different modules. In one implementation, the data 508 may include, for example, detection data 512, key generation data 514, communication data 516, and other data 518.

In various embodiments, the detection module 520 may be configured to obtain a plurality of counter values associated with a secondary node among the plurality of secondary nodes 206. The plurality of counter values is configured in the UE 202. In various embodiments, the plurality of counter values may be configured in a RRC reconfiguration message transmitted to the UE 202 by the MN 204. In an example, the plurality of counter values may be 1, 2,3, 4, and 5. Further, the detection module 520 may detect a PSCell change to a candidate PSCell previously camped on by the UE 202. The candidate PSCell may be associated with a secondary node of the SCG 210. The UE 202 may be moving between different PSCells of plurality of secondary nodes 206 of the SCG 210. In various embodiments, the UE 202 may detect the PSCell change to a candidate PSCell previously camped on by the UE 202, based on a list of PSCells camped on by the UE 202 maintained at the UE 202. In an example, consider the UE 202 camps on to PSCell #la associated with a secondary node SN1, moves to PSCell #1b and then PSCell #1c associated with a secondary node SN2, and back to PSCell #la associated with the secondary node SN1. In such case, the detection module 520 may detect the PSCell change of the UE 202 to the candidate PSCell (PSCell #1a) previously camped on by the UE 202. Data related to detection of the PSCell change of the UE 202 may be stored as the detection data 512 in the memory 504.

In various embodiments, the key generation module 522 may be configured to receive the detection data 512 from the detection module 520. Further, the key generation module 522 may be configured to generate a security key for establishing security context between the UE 202 and the candidate PSCell, based on a counter value among the plurality of counter values. The key generation module 522 may select the counter value among the plurality of counter values based on a state associated with each of the plurality of counter values. The state associated with the counter value is one of, a used state and an unused state. In various embodiments, the key generation module 522 may maintain the state associated with the counter value. In another embodiment, the key generation module 522 may receive the state of the counter value from the MN 204.

In various embodiments, the key generation module 522 may implement a Key Distribution Function (KDF) for generation/derivation of the security key (S-K_{gNB}) using the counter value. A person skilled in the art will appreciate that other techniques/methods may be used to generate the security key based on the counter value. Referring again to FIG. 4, the key generation module 522 may generate the security key by providing the counter value ‘2’ to the KDF at step 9. Referring back to FIG. 5, the generated security key and the counter value used for generation of the security key, and the state of the counter value may be stored as the key generation data 514.

In various embodiments, the communication module 524 may be configured to receive the counter value from the key generation module 522. Further, the communication module 524 may be configured to transmit the counter value to the master node 204. The master node 204 generates the security key for establishing the security context based on the counter value. In various embodiments, the communication module 524 may be configured to transmit the counter value directly to the master node 204, as shown in step 11A in FIG. 4. In another embodiment, the communication module 204 may transmit the counter value to the master node 204, via the secondary node associated with the SCG 210, as shown in steps 12A and 12B. Also, the communication module 524 may provide the counter value used to generate security key to the secondary node via the master node 204 as shown in steps 14 and 15, so that the SN ensures it uses the same key avoiding key mismatch. The counter value transmitted to the MN 204 may be stored as the communication data 516 in the memory 504.

The other data 518 may store data, including temporary data and temporary files, generated by the one or more modules 510 for performing the various functions of the UE 202. The one or more modules 510 may also include the other modules 526 to perform various miscellaneous functionalities of the UE 202. The other data 518 may be stored in the memory 504. It will be appreciated that the one or more modules 510 may be represented as a single module or a combination of different modules.

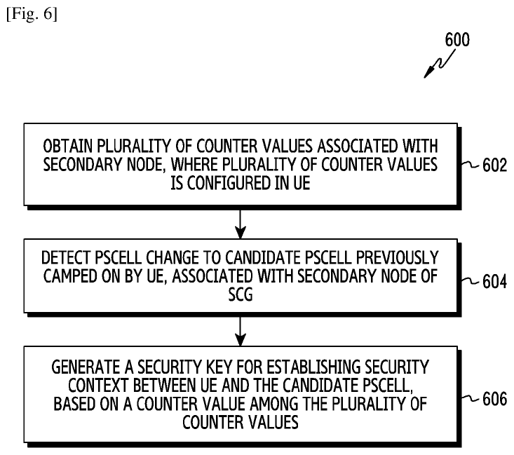

FIG. 6 shows an exemplary flow chart illustrating method steps for establishing the security context between the UE 202 and the secondary node of the SCG 210, in accordance with some embodiments of the disclosure. As illustrated in FIG. 6, the method 600 may comprise one or more steps. The method 600 may be described in the general context of computer executable instructions. Generally, computer executable instructions can include routines, programs, objects, components, data structures, procedures, modules, and functions, which perform particular functions or implement particular abstract data types.

The order in which the method 600 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 602, a plurality of counter values associated with a secondary node among a plurality of secondary nodes 206 may be obtained. The plurality of counter values is configured in the UE 202. In various embodiments, the plurality of counter values may be configured in a RRC reconfiguration message transmitted to the UE 202 by the MN 204.

At step 604, a PSCell change to a candidate PSCell previously camped on by the UE 202 may be detected. The candidate PSCell may be associated with a secondary node of the SCG 210. In various embodiments, the PSCell change the candidate PSCell previously camped on by the UE 202 may be detected based on a list of PSCells camped on by the UE 202 maintained at the UE 202.

At step 606, the security key may be generated for establishing security context between the UE 202 and the candidate PSCell, based on a counter value among the plurality of counter values. The counter value may be selected among the plurality of counter values based on a state associated with each of the plurality of counter values. The state associated with the counter value is one of, a used state and an unused state.

### Computer System

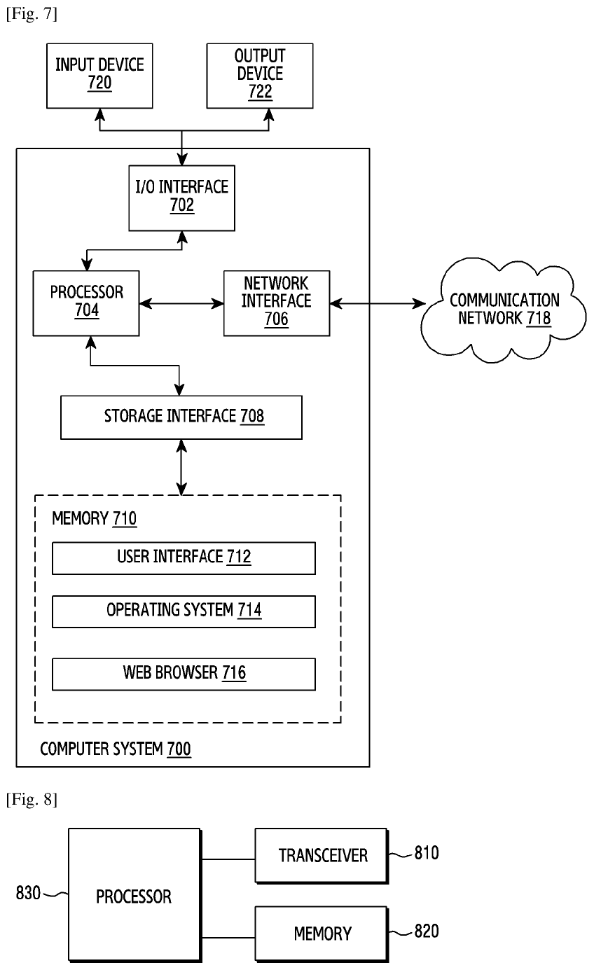

FIG. 7 illustrates a block diagram of an exemplary computer system 700 for implementing embodiments consistent with the disclosure. In various embodiments, the computer system 700 may be the master node 204. In various embodiments, the computer system 700 may be the UE 202. Thus, the computer system 700 may be used to establish the security context between the UE 202 and the secondary node. The computer system 700 may comprise a Central Processing Unit 704 (also referred as “CPU” or “processor”). The processor 704 may comprise at least one data processor. The processor 704 may include specialized processing units such as integrated system (bus) controllers, memory management control units, floating point units, graphics processing units, digital signal processing units, etc.

The processor 704 may be disposed in communication with one or more input/output (I/O) devices (not shown) via I/O interface 702. The I/O interface 702 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 702, the computer system 700 may communicate with one or more I/O devices. For example, the input device 720 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 722 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 704 may be disposed in communication with the communication network 718 via a network interface 706. The network interface 706 may communicate with the communication network 718. The network interface 706 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 718 may include, without limitation, a direct interconnection, local area network (LAN), wide area network (WAN), wireless network (e.g., using Wireless Application Protocol), the Internet, etc. The network interface 706 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 718 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 704 may be disposed in communication with a memory 710 (e.g., RAM, ROM, etc. not shown in FIG. 7) via a storage interface 708. The storage interface 708 may connect to memory 710 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 710 may store a collection of program or database components, including, without limitation, user interface 712, an operating system 714, web browser 716 etc. In some embodiments, computer system 700 may store user/application data, such as, the data, variables, records, etc., as described in this disclosure. Such databases may be implemented as fault-tolerant, relational, scalable, secure databases such as Oracle® or Sybase®.

The operating system 714 may facilitate resource management and operation of the computer system 700. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™ OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLER ANDROID™, BLACKBERRY® OS, or the like.

In some embodiments, the computer system 700 may implement the web browser 716 stored program component. The web browser 716 may be a hypertext viewing application, for example MICROSOFT® INTERNET EXPLORER™, GOOGLER CHROME™ MO, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 716 may utilize facilities such as AJAX™, DHTML™, ADOBE® FLASH™, JAVASCRIPT™, JAVA™, Application Programming Interfaces (APIs), etc. In some embodiments, the computer system 700 may implement a mail server (not shown in Figure) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 700 may implement a mail client stored program component. The mail client (not shown in Figure) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

FIG. 8 illustrates a structure of a UE according to an embodiment of the disclosure.

As shown in FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor. Furthermore, the UE of FIG. 8 corresponds to the UE of the FIG. 5.

The transceiver 810 collectively refers to a UE receiver and a UE transmitter, and may transmit/receive a signal to/from a base station or a network entity. The signal transmitted or received to or from the base station or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

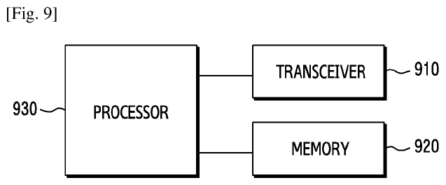

FIG. 9 illustrates a structure of a base station according to an embodiment of the disclosure.

As shown in FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor. Furthermore, the base station of FIG. 9 corresponds to the base station (a master node or a secondary node) of the FIG. 3 or the computer system of the FIG. 7

The transceiver 910 collectively refers to a base station receiver and a base station transmitter, and may transmit/receive a signal to/from a terminal (UE) or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

The processor disclosed herein may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The disclosure discloses methods, a master node, and a User Equipment (UE) for establishing security context between the UE and a secondary node of a Secondary Cell Group (SCG). In the disclosure, the master node configures multiple counter values for each secondary node of the SCG, for multiple Primary Secondary Cell (PSCell) change. The UE detects a PSCell change to a candidate PSCell which is earlier selected or previously camped on by the UE. In such case, the UE obtains the counter values configured for a secondary node associated with the candidate PSCell. The UE generates a security key for establishing security context between the UE (202) and the candidate PSCell, based on a counter value with unused state. This ensures that the UE does not use the same counter value for generating the security key while establishing security context with the candidate PSCell. Hence, the security key generated when the UE connects to a previously camped candidate PSCell is not repeated. This ensures security established between the UE and the network.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of various embodiments with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operations of FIG. 6 shows certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

In various embodiments, a method of establishing security context between a User Equipment (UE) (202) and a secondary node of a Secondary Cell Group (SCG) (210), the method comprising: configuring, by a master node (204), a plurality of counter values in a UE (202), for each of a plurality of secondary nodes (206) of a SCG (210), wherein a counter value among the plurality of counter values is used for generating a security key, upon detecting a Primary Secondary Cell (PSCell) change of the UE (202) to a candidate PSCell of a secondary node from the plurality of secondary nodes (206), wherein the candidate PSCell is previously camped on by the UE (202); wherein the security key is used to establish security context between the UE (202) and the candidate PSCell.

Preferably, configuring the plurality of counter values comprising: transmitting a Radio Resource Control (RRC) reconfiguration message comprising configuration of the plurality of counter values.

Preferably, the method, further comprising: receiving the counter value from the plurality of counter values from the UE (202); and generating the security key, based on the counter value, for establishing the security context.

Preferably, the counter value is received directly from the UE (202) or via a secondary node associated with the SCG (210).

In various embodiments, a method of establishing security context between a User Equipment (UE) (202) and a secondary node of a Secondary Cell Group (SCG) (210), the method comprising: obtaining, by the UE (202), a plurality of counter values associated with a secondary node, wherein the plurality of counter values is configured in the UE (202); detecting, by a UE (202), a Primary Secondary Cell (PSCell) change to a candidate PSCell previously camped on by the UE (202), associated with a secondary node of a SCG (210); and generating, by the UE (202), a security key for establishing security context between the UE (202) and the candidate PSCell, based on a counter value among the plurality of counter values.

Preferably, the counter value is selected among the plurality of counter values based on a state associated with each of the plurality of counter values, wherein the state is one of, a used state and an unused state.

Preferably, the plurality of counter values is configured using a Radio Resource Control (RRC) reconfiguration message transmitted by a master node (204) associated with the SCG (210).

Preferably, the method further comprising: transmitting the counter value to a master node (204), wherein the master node (204) generates the security key for establishing the security context based on the counter value.

Preferably, the transmitting comprises one of: transmitting the counter value directly to the master node (204); and transmitting the counter value to the master node (204), via a secondary node associated with the SCG (210).

Preferably, the method further comprising: transmitting the counter value to the secondary node associated with the SCG (210), via a master node (204).

In various embodiments, A master node (204) for establishing security context between a User Equipment (UE) (202) and a secondary node of a Secondary Cell Group (SCG) (210), the master node (204) comprises: a processor (306); and a memory (304), wherein the memory (304) stores processor-executable instructions, which, on execution, causes the processor (306) to: configure a plurality of counter values in a UE (202), for each of a plurality of secondary nodes (206) of a SCG (210), wherein a counter value among the plurality of counter values is used for generating a security key, upon detecting a Primary Secondary Cell (PSCell) change of the UE (202) to a candidate PSCell of a secondary node from the plurality of secondary nodes (206), wherein the candidate PSCell is previously camped on by the UE (202); wherein the security key is used to establish security context between the UE (202) and the candidate PSCell.

Preferably, the processor (306) configures the plurality of counter values by: transmitting a Radio Resource Control (RRC) reconfiguration message comprising configuration of the plurality of counter values.

Preferably, the processor (306) is further configured to: receive the counter value from the plurality of counter values from the UE (202); and generate the security key, based on the counter value, for establishing the security context.

Preferably, the processor (306) is configured to receive the counter value directly from the UE (202) or via a secondary node associated with the SCG (210).

In various embodiments, a User Equipment (UE) (202) for establishing security context between the UE (202) and a secondary node of a Secondary Cell Group (SCG) (210), the UE (202) comprises: a processor (506); and a memory (504), wherein the memory (504) stores processor-executable instructions, which, on execution, causes the processor to: obtain a plurality of counter values associated with a secondary node, wherein the plurality of counter values is configured in the UE (202); detect a Primary Secondary Cell (PSCell) change to a candidate PSCell previously camped on by the UE (202), associated with a secondary node of a SCG (210); and generate a security key for establishing security context between the UE (202) and the candidate PSCell, based on a counter value among the plurality of counter values.

Preferably, the processor (506) selects the counter value among the plurality of counter values based on a state associated with each of the plurality of counter values, wherein the state is one of, a used state and an unused state.

Preferably, the plurality of counter values is configured using a Radio Resource Control (RRC) reconfiguration message transmitted by a master node (204) associated with the SCG (210).

Preferably, the processor (506) is configured to: transmit the counter value to a master node (204), wherein the master node (204) generates the security key for establishing the security context based on the counter value.

Preferably, the processor (506) is configured to transmit the counter value directly to the master node (204) or via a secondary node associated with the SCG (210).

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

| Referral Numerals: Referral Number | Description |
|---|---|
| 200 | Exemplary environment |
| 202 | UE |
| 204 | Master node |
| 208 | Plurality of secondary nodes |
| 210 | SCG |
| 300 | Detailed diagram |
| 302 | I/O interface |
| 304 | Memory |
| 306 | Processor |
| 308 | Data |
| 310 | Modules |
| 312 | Configuration data |
| 314 | Communication data |
| 316 | Key generation data |
| 318 | Other data |
| 320 | Configuration module |
| 322 | Communication module |
| 324 | Key generation module |
| 326 | Other modules |
| 500 | Detailed diagram |
| 502 | I/O interface |
| 504 | Memory |
| 506 | Processor |
| 508 | Data |
| 510 | Modules |
| 512 | Configuration data |
| 514 | Communication data |
| 516 | Key generation data |
| 518 | Other data |
| 520 | Configuration module |
| 522 | Communication module |
| 524 | Key generation module |
| 526 | Other modules |
| 700 | Computer system |
| 702 | I/O interface |
| 704 | Processor |
| 706 | Network interface |
| 708 | Storage interface |
| 710 | Memory |
| 712 | User interface |
| 714 | Operating system |
| 716 | Web browser |
| 718 | Communication network |
| 720 | Input device |
| 722 | Output device |

1. A method performed by a user equipment (UE) in a wireless communication system, the method comprising:
receiving, from a master node (MN), a configuration including a plurality of counter values corresponding to a plurality of candidate secondary nodes (SNs);
identifying a target SN among the plurality of candidate SNs;
generating a first security key for the target SN by using a counter value corresponding to the target SN; and
transmitting, to the MN, information on the counter value used for the first security key for the target SN.

2. The method of claim 1,
wherein the information is transmitted to the MN for generating a second security key based on the information.

3. The method of claim 1, further comprising:
transmitting, to the target SN, the information on the counter value used for the first security key for the target SN.

4. The method of claim 1,
wherein the first security key is generated based on a value of the counter value and a length of the counter value.

5. A user equipment (UE) in a wireless communication system, the UE comprising:
a transceiver; and
at least one processor coupled with the transceiver and configured to:
receive, from a master node (MN), a configuration including a plurality of counter values corresponding to a plurality of candidate secondary nodes (SNs),
identify a target SN among the plurality of candidate SNs;
generate a first security key for a target SN by using a counter value corresponding to the target SN, and
transmit, to the MN, information on the counter value used for the first security key for the target SN.

6. The UE of claim 5,
wherein the information is transmitted to the MN for generating a second security key based on the information.

7. The UE of claim 5, wherein the at least one processor further configured to:
transmit, to the target SN, the information on the counter value used for the first security key for the target SN.

8. The UE of claim 5,
wherein the first security key is generated based on a value of the counter value and a length of the counter value.

9. A method performed by a base station (BS) which is a master node (MN) for a user equipment (UE) in a wireless communication system, the method comprising:
transmitting, to the UE, a configuration including a plurality of counter values corresponding to a plurality of candidate secondary nodes (SNs);
receiving, from the UE, information on a counter value used for a first security key for a target SN among the plurality of candidate SNs.

10. The method of claim 9, the method further comprises:
generating a second security key based on the information on the counter value;
transmitting, to the target SN, the second security key.

11. The method of claim 9, the method further comprises:
receiving, from the target SN, the information on the counter value used for the first security key for the target SN among the plurality of candidate SNs,
generating a second security key based on the information on the counter value;
transmitting, to the target SN, the second security key.

12. The method of claim 9,
wherein the second security key is generated based on a value of the counter value and a length of the counter value.

13. A base station (BS) which is a master node (MN) for a user equipment (UE) in a wireless communication system, the BS comprising:
a transceiver; and
at least one processor coupled with the transceiver and configured to:
transmit, to the UE, a configuration including a plurality of counter values corresponding to a plurality of candidate secondary nodes (SNs), receive, from the UE, information on a counter value used for a first security key for a target SN among the plurality of candidate SNs.

14. The BS of claim 13, wherein the at least one processor further configured to:
generate a second security key based on the information on the counter value,
transmit, to the target SN, the second security key.

15. The BS of claim 14,
wherein the second security key is generated based on a value of the counter value and a length of the counter value.
